(19) United States
(12) Patent Application Publication
(10) Pub. No.: US 2005/0155634 A1
(43) Pub. Date: Jul. 21, 2005

(54) Method for simultaneous enzymatic desizing and kiering of cellulose-containing material

(76) Inventors: Wolfgang Lillotte, Moenchengladbach (DE); Gero Reichert, Hilden (DE)

Correspondence Address: COGNIS CORPORATION;PATENT DEPARTMENT, 300 BROOKSIDE AVENUE, AMBLER, PA, 19002, US

(21) Appl. No.: 10/504,286

(22) PCT Filed: Feb. 4, 2003
(86) PCT No.: PCT/EP03/01059

(30) Foreign Application Priority Data
Feb. 12, 2002 (DE) 102 05 929.2

(51) Int. Cl. B08B 3/14

(52) U.S. Cl. 134/42

(57) ABSTRACT

A process for simultaneously desizing and scouring cellulose-containing material involving: (a) providing a first aqueous solution containing at least one pectinase; (b) providing a cellulose-containing material; (c) contacting (b) with (a) at a pH of less than 7 and a temperature of about 50° C. to form a treated cellulose-containing material; (d) providing a second aqueous solution containing a dispersant and a complexing agent; and (e) washing the treated cellulose-containing material in the second aqueous solution at an elevated temperature to form a washed cellulose-containing material.

This invention relates to a process for the simultaneous enzymatic desizing and scouring of cellulose-containing material, preferably cotton.

The processing of cellulose-containing material, preferably cotton, for the production of fibers and woven fabrics suitable for use in textile products involves a number of steps. First, the fibers are spun to a yarn which is then woven to a fabric. The fabric may then be dyed and treated with various textile finishes.

In order to make the yarns more resistant for weaving, they are generally treated with sizing agents or sizes for short. Sizes are generally solutions, oils, dispersions or emulsions of sizes which impart smoothness, compactness, flexibility and strength to yarns so that processing on looms is improved. Weaving is often followed by dyeing or printing processes. These processes generally presuppose that no more size is present on the woven fabric. Accordingly, an important step in the processing of cotton is the desizing of the woven intermediate products. The desizing step itself obviously depends to a large extent on the size used. Conventional sizes include, for example, polyacrylates, polyvinyl alcohols or carboxymethyl cellulose. In addition, starch is also widely used as a size. Besides purely physicochemical washing methods, various enzymatic processes have also been developed for desizing woven fabrics sized with starch. For example, α-amylases are used to remove starch from woven fibres. The enzymes used decompose the starch which can then be removed from the fibers in a washing process.

Besides desizing, cotton fabrics also have to be scoured or kier-boiled. This is a process step which is designed to remove soils in the form of fat, resins, starch, wax and the like from the fiber surface by boiling of the cellulose fibers, preferably with dilute caustic soda solution, and thus to make the fibers more receptive to the following bleaching agents and dyes. Whereas scouring is carried out under normal pressure, kier-boiling is generally carried out under pressure at ca. 120° C.

Scouring may also be carried out in the presence of enzymes. Thus, DD 264 947 A1 claims a process for the enzymatic pretreatment of cotton in which a fungal enzyme complex, preferably a cellulase complex, is used as a desizing agent. At the same time as removal of the starch size, the cotton impurities are also removed by hydrolysis. However, the process described in DD 264 947 is not defined by any exact parameters, more particularly the pH at which the enzymatic treatment takes place.

U.S. 2002/0002746 A1 describes a process for the alkaline enzymatic desizing of cotton textiles. To this end, a pectinase-containing aqueous solution is contacted with the cotton textile at a pH of 9 or higher and at temperatures of 50° C. It is crucially important for the aqueous solution to be adjusted to a low calcium concentration.

One disadvantage of this process, which is now widely used in the textile industry, is the fact that it has to be carried out at a comparatively alkaline pH value. This results in unwanted pollution of the environment by the alkaline wastewater.

Accordingly, the problem addressed by the present invention was to provide a process for the simultaneous desizing and scouring of cellulose-containing material, preferably cotton, which would not have any of the above-mentioned disadvantages.

It has surprisingly been found that simultaneous desizing and scouring are possible through the choice of certain process parameters.

The present invention relates to a process for the simultaneous enzymatic desizing and scouring of cellulose-containing material in which (a) an aqueous solution containing at least one pectinase is prepared and is contacted in step (b) with the cellulose-containing material, the pH of the solution being below 7 and a temperature of at least 50° C. having to be adjusted, and the treated cellulose-containing material is then washed at elevated temperature in step (c) with an aqueous solution containing wetting agents or dispersants and complexing agents and is then optionally subjected to further processing steps.

The process according to the invention is preferably applied to cotton. Cotton is understood to be both the seed hairs of the yellow-flowering (gossypetin) cotton plant (Gossypium, order Malvales), which has been cultivated in tropical to subtropical regions for more than 5,000 years, and the textile fibers obtained therefrom (abbreviation CO according to DIN 60001 TI.4 (08/1991). The long hairs consist of more than 90% cellulose with average molecular weights of 320,000 and an average degree of polymerization of 10,000 to 14,000 (cleaned 500-3000). The fiber stem, the so-called secondary wall, contains only ca. 5% non-celluloses whereas the thin outer skin or primary wall consists of ca. 90% cotton wax and pectin and only 10% cellulose (far higher cellulose contents have also been mentioned). According to electron micrographs, the individual seed hair (diameter ca. 20 mm) consists of a single cell of which the cell wall is formed by various layers of differently oriented cellulose fibrils between 3 and 5 nm in diameter.

Besides pure cotton, cotton blends may also be treated by the process according to the invention. Such blends may contain both natural and synthetic fibers, for example polyolefin fibers, polyester fibers, nylon or—as an example of natural fibers—linen and other suitable fibers.

The process according to the invention uses pectinase for desizing starch-containing sizes. In one advantageous embodiment, the enzyme preparations or enzymes used have a pectinase activity of ≧75 PTF/mg and an α-amylase activity of ≧22400 α-TU/g. A modified pectinase with the CAS No. 9033-35-6 is particularly preferred. This product is marketed by AB Enzymes under the name of Biotouch® PTA. The IUB number is EC 4.2.2.10. It is a pectinase/α-amylase mixture which is obtained from genetically modified strains of non-pathogenic microorganisms.

In the process according to the invention, an aqueous solution of the pectinase is initially prepared in step a). This aqueous solution contains the pectinase in a concentration of 0.5 to at most 5% by weight and preferably in a concentration of 1 to 3% by weight, based on the aqueous solution. The aqueous solution from step (a) is then contacted with the cellulose-containing material. This can be done both in batches and continuously.

In the batch treatment, the fabric is first soaked with the aqueous solution in a vat. It is important to ensure that the temperature of the aqueous solution during the treatment is at least 50° C. to guarantee adequate enzyme activity. In addition, it is crucially important to the invention that the pH of the aqueous solution is below 7 and preferably in the range from 5.5 to 6.5. The pH may be adjusted by the usual addition of acids, for example acetic acid. After the woven fabric has been soaked with the aqueous solution, it is rolled up, for example into a batch, and kept moist until the pectinase has reacted with the cotton. In a preferred embodiment, the cellulose-containing material must be in contact with the aqueous solution for at least 1 minute, although contact times of 10 minutes to 20 hours are needed to obtain a complete reaction, particularly in the batch process described above. After the reaction time, the fabric is washed with an aqueous solution containing wetting agents or dispersants and complexing agents at elevated temperature, i.e. above 60° C. and preferably in the range from 80 to 100° C. Typically, temperatures of 90 to 95° C. are adjusted in this step. The reason for adding wetting agents is that they guarantee adequate moistening and wetting of the cotton. Suitable wetting agents are known to the expert and may be nonionic or anionic. It can be of advantage to use ethoxylated fatty alcohols. In addition, complexing agents have to be added in order in particular to remove calcium ions, which are naturally present in cotton, from the aqueous dispersion. Suitable complexing agents are, in particular, phosphonic acids, but also any other complexing agents known to the expert in the textiles field. If no complexing agents were to be used, residues could remain on the fibers through salt formation and precipitation. On completion of the washing step, the fabric may be dried and subjected to further process steps, preferably bleaching.

Besides the batch process described above, the process according to the invention may also be carried out as a continuous process. In this case, the woven fabric is passed continuously through a bath containing the pectinase and wetting agent and, after washing and drying, may be bleached, for example, and then subjected to other treatment steps, for example dyeing. In the continuous process, the residence time in the aqueous solution (a) is preferably 1 to 10 minutes. It is normal in the continuous process to have to increase the reaction temperature, preferably to values above 60° C., in order to guarantee adequate desizing.

The process according to the invention leads to effective desizing and, at the same time, scouring of the treated fabric. It is suitable both for pure cotton and for cotton blends. In addition, it has been found that the quantity of bleaching agent to be used in a following alkaline bleaching step can be reduced by up to 30% by the process according to the invention.

It can also be of advantage to use the pectinase together with other suitable enzymes, preferably cellulase, in which case ratios by weight of pectinase to cellulase of 10:1 to 1:1 are preferred. Other auxiliaries known to the expert, for example defoamers, may also be used in the process according to the invention.

### EXAMPLES

The process according to the invention was carried out as follows: test cotton fabrics (100% grey cotton cloth and 100% twill cloth) were contacted at 50° C. with an aqueous solution containing 5 ml/l of a wetting agent (Cottoclarin BAM, Cognis) and 5 ml/l of a pectinase (CAS No. 9035-35-6, Biotouch PTA, AB Enzymes). The pH of the aqueous solution had been adjusted to 6.5 with acetic acid. The fabrics were immersed in a bath containing the aqueous pectinase-containing solution, rolled into a cloth batch and kept moist and rotated for 20 hours. The fabrics were then washed at 95° C. with an aqueous solution containing wetting agents or dispersants (Cottoclarin BAM, 1 ml/l) and a complexing agent (Securon 540, Cognis, 1 ml/l) and then dried in air. The dry fabrics were subsequently immersed in an aqueous solution containing 6 ml/kg NaOH (50%), 3 ml/kg Cottoclarin BAM, 5 ml/kg Stabilol P (Cognis) and 40 ml/kg H₂O₂ (35%) and then treated for 15 minutes with saturated steam at 100° C.

The whiteness of the fabrics was measured with a spectral photometer (Table 1).

TABLE 1

| | Whiteness | % Reflectance |
|---|---|---|
| | (Berger) | (at 460 nm) |
| Grey cotton cloth (100%) untreated | 21 | 61 |
| After desizing/scouring | 23 | 60 |
| After bleaching | 79 | 87 |
| Twill cloth (100%) untreated | 22 | 60 |
| After desizing/scouring | 26 | 61 |
| After bleaching | 74 | 86 |

Another test was carried out with terry hand towels (10% cotton) in a Thies Ecosoft machine. The liquor ratio (textile material:treatment liquor) was 1:10. The textile material was passed through the machine at a speed of 100 m/min. The textile material was first heated to 40° C., after which an aqueous solution of a anticrease agent and a wetting agent (1 ml/l Breviol PAM-N, 1 ml/l Foryl 5678) was added. The pH of the liquor was adjusted to 5.5 with acetic acid. The liquor was then heated to 55° C. and an aqueous solution containing 3% pectinase (Forylase PA) and 1% of a cellulase (Forylase CE) was added. The textile material was left in the liquor for 45 minutes at 55° C. and was then washed at 95° C. with an aqueous solution containing wetting agent and complexing agent. The textile material was subsequently rewashed for 10 minutes at 90° C. with an aqueous solution containing a dispersant.

The whiteness of the towels was measured as in Example 1. The results are set out in Table 2.

| | Whiteness | % Reflectance |
|---|---|---|
| | (Berger) | (at 460 nm) |
| Terry (100%) untreated | 7 | 52 |
| After desizing/scouring | 22 | 60 |

1-13. (canceled)

14. A process for simultaneously desizing and scouring cellulose-containing material comprising:
(a) providing a first aqueous solution containing at least one pectinase;
(b) providing a cellulose-containing material;
(c) contacting (b) with (a) at a pH of less than 7 and a temperature of about 50° C. to form a treated cellulose-containing material;
(d) providing a second aqueous solution containing a dispersant and a complexing agent; and
(e) washing the treated cellulose-containing material in the second aqueous solution at an elevated temperature to form a washed cellulose-containing material.

15. The process of claim 14 wherein the cellulose-containing material contains cotton.

16. The process of claim 14 wherein the pectinase has a pectinase activity of about ≧75 PTF/mg and an α-amylase activity of about ≧22,400 α-TU/g.

17. The process of claim 14 wherein the pectinase corresponds to CAS No. 9033-35-6.

18. The process of claim 14 wherein the pectinase is present in the first aqueous solution in an amount of from about 0.5 to 5% by weight, based on the weight of the first aqueous solution.

19. The process of claim 14 wherein the pectinase is present in the first aqueous solution in an amount of from about 1 to 3% by weight, based on the weight of the first aqueous solution.

20. The process of claim 14 wherein (b) is contacted with (a) for a period of at least 1 minute.

21. The process of claim 14 wherein (c) is performed at a pH of from about 5 to 7.

22. The process of claim 14 wherein (c) is performed at a temperature of from about 50 to 55° C.

23. The process of claim 14 wherein (c) is performed at a pH of from about 5.5 to 6.5.

24. The process of claim 14 wherein the first aqueous solution further contains a cellulase.

25. The process of claim 14 further comprising subjecting the washed cellulose-containing material to an alkaline bleaching step.

26. The process of claim 14 wherein (e) is performed at a

27. The process of claim 14 wherein (e) is performed at a temperature of from about 80 to 100° C.
